(19) United States
(12) Patent Application Publication
(10) Pub. No.: US 2007/0003765 A1
(43) Pub. Date: Jan. 4, 2007

(54) Acoustically optimized multi-wall sheet

(76) Inventors: Roderich Kammerer, Bad Honnef (DE); Peter Schwarz, Krefeld (DE); Werner Strassen, Ratingen (DE)

Correspondence Address: BAYER MATERIAL SCIENCE LLC, 100 BAYER ROAD, PITTSBURGH, PA, 15205, US

(21) Appl. No.: 11/475,411

(22) Filed: Jun. 27, 2006

(30) Foreign Application Priority Data
Jun. 29, 2005 (DE) 102005030226.2

(51) Int. Cl. B32B 9/04; B32B 27/36; B32B 27/40

(52) U.S. Cl. 428/411.1; 428/412; 428/423.1

(57) ABSTRACT

A multi-layer product having improved acoustic properties is disclosed. The product contains a multi-wall sheet made of a thermoplastic composition and a first functional layer abutting to said sheet made of a material having shear modulus of 0.5 to 2000 MPa and loss factor tan δ of at least 0.1. An additional embodiment wherein the product further includes a second functional layer containing polymethyl methacrylate or polycarbonate, abutting said first functional layer is also disclosed. The product is especially suitable for making roofing elements.

### FIELD OF THE INVENTION

The present invention relates to an article of manufacture and more particularly to a thermoplastically made multi-wall sheet.

### BACKGROUND OF THE INVENTION

Multi-wall sheets made of thermoplastics, such as e.g. polycarbonate, have already been known for some time and are widely used as roofing for greenhouses and conservatories owing to their low weight per unit area, their excellent thermal insulation properties and their break resistance.

Precisely when multi-wall sheets are used as roof panes in these applications, however, marked disadvantages are displayed when it rains. Because of the low weight per unit area and the low rigidity of the thermoplastics employed, the noise arising during rainfall is perceived as loud and unpleasant since the roof panels are transformed, so to speak, into large drum membranes.

There has not yet been any satisfactory solution to this problem. It is currently being proposed, as indicative of the solution, to introduce silicone into the outermost chambers of the multi-wall sheet facing the rain, in order to alleviate the problem. However, this only leads to a certain improvement, which is insufficient for many applications.

The object still exists, therefore, of providing a multi-wall sheet that leads to a lower loudness level with given rainfall than occurs in the case of a known multi- wall sheet.

Surprisingly, it has now been found that this object is achieved by a coating of a multi-wall sheet made of thermoplastics, as described below. This invention provides a coated multi-wall sheet of this type.

### BRIEF DESCRIPTION OF THE FIGURE

FIG. 1 shows the acoustic properties of the inventive sheet set in comparison to a corresponding sheet outside the scope of the invention.

### SUMMARY OF THE INVENTION

A multi-layer product having improved acoustic properties is disclosed. The product contains a multi-wall sheet made of a thermoplastic composition and a first functional layer abutting to said sheet made of a material having shear modulus of 0.5 to 2000 MPa and loss factor tan δ of at least 0.1. An additional embodiment wherein the product further includes a second functional layer containing polymethyl methacrylate or polycarbonate, abutting said first functional layer is also disclosed. The product is especially suitable for making roofing elements.

### DETAILED DESCRIPTION OF THE INVENTION

The multi-wall sheet according to the invention comprises, as the base layer, a conventional multi-wall sheet made of a thermoplastic. Suitable thermoplastics are e.g. polycarbonate, polymethyl methacrylate and polyolefins, such as polyethylene and polypropylene. Among these, polycarbonate is preferred. The production of these multi-wall sheets may take place e.g. by extrusion and is familiar to the person skilled in the art.

The multi-wall sheet according to the invention further comprises on at least one side of this base layer, preferably the side facing the rain, a first functional layer, which is formed from a material with high transparency, preferably low material rigidity (expressed as the shear modulus) and a high loss factor (expressed as tan δ, determined in accordance with the standard ISO 6721-2B in the frequency range of 0.1 to 10 Hz). The loss factor here is the ratio between loss modulus and storage modulus.

The material of the first functional layer generally exhibits a shear modulus of 0.5 to about 2000 MPa, preferably 0.5 to 500 MPa, particularly preferably 0.6 to 5 MPa.

At the same time, the material of the first functional layer preferabley possesses a loss factor tan δ of at least 0.1, preferably at least 0.4, particularly preferably 0.5. In general a loss factor tan δ may have values up to 2.

Suitable materials for forming the first functional layer are e.g. silicone gels, such as Silopren® U-Gel TP 3636, available from GE Bayer Silicones GmbH & Co KG, or polyurethanes, and preferably aliphatic polyurethanes, available for example from Bayer MaterialScience.

Silicone gels of the present invention are preferably partially crosslinked silicone elastomers as described in U.S. Pat. No. 4,100,627 (DE-A 2 711 383), herewith incorporated by reference. A silicone gel comprising a crosslinked essentially polydimethylsiloxane having a penetration of from 20 to 60 millimeters being prepared by mixing a methylphenylvinylsiloxy endblocked polydimethylsiloxane having a viscosity of 0.1 to 6 pascal-seconds at 25° C., a sufficient amount of a dimethylhydrogensiloxy endblocked polydimethylsiloxane having a viscosity of less than 5 pascal-seconds at 25° C., to provide an effective viscosity for the methylphenylvinylsiloxy endblocked polydimethylsiloxane of from 4.5 to 30 pascal-seconds at 25° C., a polymethylsiloxane having an average of at least three silicon-bonded hydrogen atoms per molecule present in an amount to provide a ratio of silicon-bonded hydrogen atoms to vinyl radicals in the total composition of from 0.3 to 0.74 and a catalytic amount of a compatible platinum catalyst, and thereafter curing the composition to obtain a gel is particularly preferred.

The first functional layer can comprise a polyurethane. The polyurethanes are formed from polyisocyanates and polyols. Suitable polyisocyanates are for example and preferably 1,6-hexamethylene diisocyanate (HDI), isophorone diisocyanate (IPDI), methylene diphenyl isocyanate (MDI or PMDI), and its hydrogenated aliphatic form (e.g. Desmodur® W), toluylene diisocyanate (TDI), naphthalene diisocyanate (NDI), phenylene diisocyanate (PPDI) and its hydrogenated form (CHDI), and all biurets and/or prepolymers and/or mixtures thereof. Polyether polyols, polyester polyols and/or polycarbonate polyols and mixtures thereof are used as the polyol component. Aliphatic polyurethanes are preferred, and particularly preferably those of a polyether polyol and an IPDI-based prepolymer. The following products from Bayer MaterialScience AG can for example be used: Baytec® VP.PU 50BV14 and Desmodur® VP-PU 0316.

The polyurethanes usually have a Shore A hardness of <70, preferably <50, particularly preferably <40 and very particularly preferably <30 (Shore A hardness determined according to DIN 53 505). They have a shear modules as mentioned above.

The polyurethanes can also contain brighteners, flame retardants and UV and oxidation stabilizers.

The first functional layer can for example be cast onto the base layer using low-pressure casting machines or spraying machines or by means of a slit die, knife-coating, pressing or rolling.

The invention also includes a process in which the first functional layer, preferably of polyurethane or a silicone gel, and particularly preferably of polyurethane, is applied to the twinwall sheet after extrusion and directly rolled onto and/or adhesively bonded to the thermoplastic film, the polyurethane or silicone gel additionally acting as an adhesive. The polyurethane or silicone gel is thus spread smoothly by the roller and adheres to the thermoplastic and the film. The finished composite material can thus be produced in one step.

The first functional layer may contain additional substances, such as e.g. photochromic and/or phototropic pigments or IR absorbers.

These are commercially available for example from Sigma-Aldrich or Rodenstock. Their formulae can be found in U.S. Pat. No. 6,166,129 and DE-A 10103784. In general these wall plates can also be used for transparent heat insulation. In addition it is also possible to use thermotropic, thermochromic, thermoelectrochromic and -gaschromic and IR absorbers such as for example lanthanum hexaboride.

The first functional layer preferably has a layer thickness of 1.5 to 2 mm.

In a preferred embodiment, the multi-wall sheet according to the invention comprises, on the side of the first functional layer facing away from the base layer, a second functional layer, which protects the layers below from mechanical influences and UV rays.

Suitable materials for this second functional layer are e.g. polymethyl methacrylate, polymethyl methacrylate or polycarbonate, which may additionally contain conventional UV absorbers. Polymethyl methacrylate is preferred. Suitable polycarbonates are described for example in EP-A 716 919.

The second functional layer preferably has a layer thickness of 0.1 to 0.5 mm. It is preferably a film.

Owing to the low shear modulus of the first functional layer, this has the effect of an acoustic barrier layer between the base layer and the second functional layer. Owing to the high material damping of the first functional layer, the spectrum of the impact pulse of a raindrop on the sheet according to the invention is additionally spread and, at the same time, its amplitude is reduced. This leads to clear sound insulation in the total level (typically about 7 dB) compared with a multi-wall sheet that has not been modified according to the invention.

Without wishing to commit to an explanation of this phenomenon, the following effects inter alia appear to contribute to it: an extension of the force-time pulse by the first functional layer, a damping of the base layer and, in the presence of a second functional layer, by an elastic decoupling of the second functional layer from the base layer.

The process for the production of the sheet according to the invention comprises the production of a conventional multi-wall sheet and the subsequent application of the first and second functional layers. This application generally takes place by pouring, coating, coextrusion or laminating, with pouring being preferred.

The sheets according to the invention may be employed for exterior or interior use, wherever roofing elements are exposed to rain, especially for the roofing of greenhouses and conservatories.

### EXAMPLES

The effect of the improved sound insulation and dissipation was demonstrated on the test rig described below:

The test structure consisted of a frame of sand-lime bricks about 1 m high topped with a test-piece holding device for a sample size of 80×80 cm.

The test chamber is anechoically lined with open-pored sound-insulating mats to avoid standing waves.

Above the test rig, there is a nozzle that simulates raindrops impacting on the test sheet. In preliminary tests, it was demonstrated that variations in flow scarcely affected the test result.

The test structure described is comparable with the one according to the standard DIN EN ISO 140-18.

In this test structure, water was sprinkled on to an uncoated multi-wall sheet of Makrolon® 1243 (a polycarbonate of Bayer MaterialScience AG, Leverkusen, Germany) on the one hand and an identical multi-wall sheet coated with a 2 mm thick layer of Silopren® U-Gel TP 3636 silicone gel (a product of GE Bayer Silicones, Leverkusen, Germany) having loss factor in the frequency range of 0.1 to 10 Hz of 0.75 to 1.2 and elastic shear modulus of 0.7 to 5 MPa and on top of this a 0.25 mm thick film of polycarbonate.

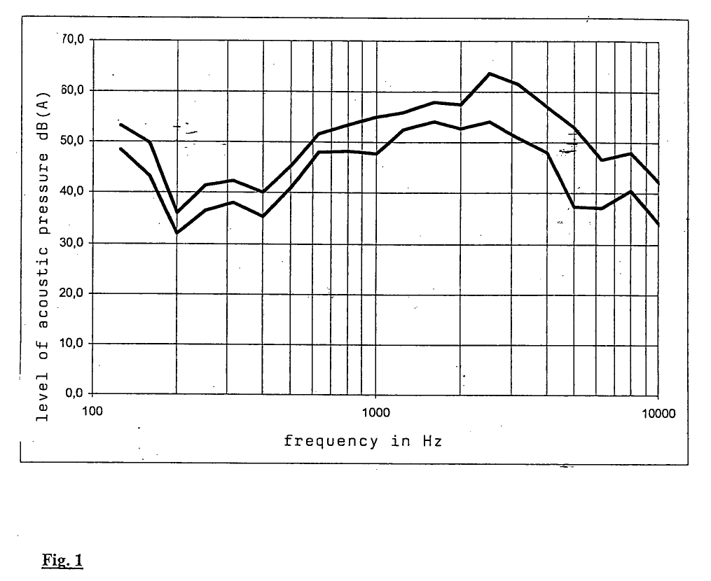

FIG. 1 shows the measurement of the diffuse sound level in the test chamber, the upper curve representing the pattern for the uncoated multi-wall sheet not according to the invention and the lower curve showing the diffuse sound level of the multi-wall sheet according to the invention.

The uncoated multi-wall sheet not according to the invention gave a total level of 68.7 dB(A) in the frequency range under consideration and the multi-wall sheet according to the invention a total level of 61.6 dB(A).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A multi-layer product comprising
(i) a multi-wall sheet made of a thermoplastic composition and abutting thereto
(ii) a first functional layer made of a material having a shear modulus of 0.5 to 2000 MPa.

2. A multi-layer product according to claim 1 having a shear modulus of 0.5 to 2000 MPa and loss factor tan δ of at least 0.1.

3. The multi-layer product according to claim 2, wherein shear modulus is 0.6 to 5 Mpa and loss factor tan δ is at least 0.5.

4. The multi-layer product according to claim 1 wherein thermoplastic composition contains at least one member selected from the group consisting of polycarbonate, polymethyl methacrylate and polyolefin.

5. The multi-layer product according to claim 1 wherein the first functional layer is 1.5 to 2 mm thick.

6. The multi-layer product according to claim 1 wherein the material is silicone gel.

7. The multi-layer product according to claim 1 wherein the material of the first functional layer is a polyurethane.

8. The multi-layer product according to claim 7 wherein the material is aliphatic polyurethane.

9. The multi-layer product according to claim 1 further comprising (iii) a second functional layer containing polymethyl methacrylate or polycarbonate, abutting said (ii).

10. The multi-layer product according to claim 9 wherein said (iii) contains at least one conventional UV absorber.

11. The multi-layer product according to claim 7 may containing at least one phototropic pigment.

12. The multi-layer product according to claim 8 wherein said second functional layer is 0.1 to 0.5 mm thick.

13. A roofing element comprising the multi-layer product according to claim 1.

14. The multi-layer product according to claim 2 wherein thermoplastic composition contains at least one member selected from the group consisting of polycarbonate, polymethyl methacrylate and polyolefin.

15. The multi-layer product according to claim 2 wherein the material is silicone gel.

16. The multi-layer product according to claim 2 wherein the material of the first functional layer is a polyurethane.

17. A roofing element comprising the multi-layer product according to claim 2.
